(19) United States
(12) Patent Application Publication
(10) Pub. No.: US 2006/0283420 A1
(43) Pub. Date: Dec. 21, 2006

(54) Continuous internal combustion engine and rotary machine

(76) Inventor: Ionel Mihailescu, Toronto (CA)

Correspondence Address: YOUNG & BASILE, P.C., 3001 WEST BIG BEAVER ROAD, SUITE 624, TROY, MI, 48084, US

(21) Appl. No.: 11/481,136

(22) Filed: Jul. 5, 2006

Related U.S. Application Data
(63) Continuation-in-part of application No. 11/254,916, filed on Oct. 21, 2005.

(30) Foreign Application Priority Data
Jun. 16, 2005 (CA) 2,509,485

(51) Int. Cl. F02B 53/00

(52) U.S. Cl. 123/204

(57) ABSTRACT

A continuous internal combustion engine having a combustor operative to produce combustion gases in a combustion chamber and having a fuel and air system for delivering a mixture of fuel and air to the chamber and an ignition device. A cylindrical rotor is mounted outside the combustor for rotation about a first axis on a central shaft. This rotor has a plurality of axially extending slots formed therein and distributed about its circumference. A plurality of vanes extend radially relative to the first axis and each is mounted in the rotor for radial movement in one of the slots. A vane control mechanism moves the vanes between extended and retracted positions during one revolution. A discharge passage is formed between an extension section of the combustor and a circumferentially extending section of the rotor. Each of the vanes passes through this passage in an extended position with an extended portion of the vane substantially filling the cross-section of the passage. The combustion gases pass through the discharge passage and drive vanes located in the passage.

### PRIOR APPLICATION

This application is a continuation-in-part of U.S. patent application Ser. No. 11/254,916 filed Oct. 21, 2005, the entire contents of which are hereby incorporated by reference.

### FIELD OF THE INVENTION

The present disclosure is directed to continuous internal combustion engines, rotary combustion engines and rotary air pumps.

### BACKGROUND ART

Internal combustion engines, diesel and gasoline are well known. Also, rotary combustion engines, are well known, and examples are to be found in U.S. Pat. No. 4,073,608 issued on Feb. 14, 1978 to Christy; U.S. Pat. No. 4,241,713 issued on Dec. 30, 1980 to Crutchfield; U.S. Pat. No. 4,830,593 issued on May 16, 1989 to Byram et al.; U.S. Pat. No. 4,998,867 issued on Mar. 12, 1991 to Sakamaki et al.; U.S. Pat. No. 5,427,068 issued on. Jun. 27, 1995 to Palmer; U.S. Pat. No. 5,489,199 issued on Feb. 6, 1996 to Palmer; U.S. Pat. No. 5,522,356 issued on Jun. 4, 1996 to Palmer; U.S. Pat. No. 6,526,937 issued on Mar. 4, 2003 to Bolonkin; and U.S. Pat. No. 6,659,066 issued on Dec. 9, 2003 to Lee. In general terms, these references and others disclose rotary engines and other rotary machines that use a rotor equipped with multiple vanes to provide pumping action or to convert energy contained in expanding combustion gases into rotary motion.

These various known and patented rotary engines and machines often do not work properly and, in some cases, can fail after a short period of time. These problems and difficulties can arise from such factors as the following:

(a) When they are operating, the sliding vanes slide along and engage the internal surfaces of the rotor housing which can result in overheating and damage to the rotor, including the vanes;

(b) When the engine is operating, the rotating vanes are pushed against the internal surfaces of the rotor housing by the pressure of the combustion gases and this in turn results in loss of power and overheating;

(c) In many rotary engines, the combustion gases from the point of combustion to their exit from the engine can travel a substantial distance during which travel time they can be subjected to both compression and expansion and this situation also results in loss of power, particularly at high RPM when the gases are moving at high speed; and

(d) In the case of rotary engines that operate on the Carnot engine cycle, such engines cannot operate efficiently because, when combustion occurs, the pressure created by the combustion gases acts on two vanes so as to push in opposite directions, thereby creating counteracting forces.

In the case of conventional internal combustion engines operating on either diesel fuel or gasoline, such engines can have the following disadvantages:

(a) Whether the engine be a four stroke or two stroke engine, it has very low efficiency and looses power in the required cooling system;

(b) The mechanical leverage available to each piston in the engine is not constant and because of the small amount of leverage at the beginning and end of each piston stroke, a lot of power is lost;

(c) Because the engine is quite complicated and is made with many parts, a lot of its power is lost to friction forces; and

(d) Because this type of engine is quite heavy, a lot of power is lost when the engine must provide acceleration, powerful brakes are required in order to properly brake a vehicle equipped with the engine, and a strong vehicle body structure is required, thereby increasing the weight of the vehicle and decreasing overall efficiency.

### SUMMARY OF THE PRESENT DICLOSURE

As will be apparent from the detailed description and appended drawings which follow, the present disclosure provides, inter alia, the following advantages in the field of internal combustion engines:

(a) Because the engine employs a cylindrical rotor device with a plurality of vanes mounted for radial movement in the rotor, the engine eliminates the need for reciprocating pistons such as those used in conventional internal combustion engines;

(b) The engine can be constructed so that the pressure created by the combustion gases from a combustion chamber is exerted in an efficient manner on the vanes as they pass through a gas discharge passage, which can provide a very efficient internal combustion engine.

According to one exemplary embodiment of the present disclosure, a continuous internal combustion engine includes a combustor operative to produce combustion gases in a combustion chamber and having a fuel and air system for delivering a mixture of fuel and air to the combustion chamber, an ignition device to ignite the mixture of fuel and air, and an extension section which is open at an outer end thereof. A cylindrical rotor device is mounted outside the combustor for rotation about a first axis on a central shaft and has a cylindrical member with a plurality of axially extending slots formed therein and distributed about the circumference of the cylindrical member. This cylindrical member has an outer circular cylindrical surface and is mounted to close most of said open outer end of the extension section. A plurality of vanes extend radially relative to the first axis with each vane being mounted in the rotor device for radial movement in a respective one of the slots. Each vane is sized to fit in close proximity to adjacent sides of its respective slot. The rotor device has a vane supporting arrangement for supporting the vanes and guiding the vanes during the radial movement. The engine also has a vane control mechanism for moving each of the vanes between a fully extended position where each vane projects beyond the circular cylindrical surface a maximum distance and a fully retracted position during a revolution of the rotor device. A discharge passage for the combustion gases is formed between the extension section of the combustor and a circumferentially extending section of the circular cylindrical surface of the cylindrical member. The discharge passage is a gate through which each of the vanes passes in an extended position during operation of the engine. An extended portion of each vane located in the gate projects radially from the circular cylindrical surface and substantially fills the cross-section of the gate as taken in a radial plane defined by the respective vane. The expanding combustion gases from the combustor pass through the discharge passage and drive each extended vane located in the gate along a circumferential length of the gate in order to rotate the rotor device during operation of the engine.

In an exemplary embodiment of this engine, the rotor device has an intermediate cylindrical member and an innermost cylindrical member, both of which are concentric with the first mentioned cylindrical member which provides an outer cylindrical member. All three cylindrical members are connected to two circular end plates located at opposite ends of the cylindrical members, these end plates being rotatably mounted on their central shaft arrangement. The aforementioned vane supporting arrangement includes the intermediate and innermost cylindrical members in this embodiment.

A rotary machine of the present disclosure includes a continuous rotor device mounted for rotation about a first axis and having a cylindrical member with a plurality of axially extending slots formed therein and distributed about the circumference of the cylindrical member. The cylindrical member has an outer circular cylindrical surface. A plurality of vanes extend substantially radially and each is mounted in the rotor device for radial movement in a respective one of the slots. The rotor device has a vane supporting arrangement for supporting the vanes and guiding the vanes during the radial movement. A vane control mechanism is able to move each of the vanes between a fully extended position where each vane projects beyond the circular cylindrical surface a maximum distance and a fully retracted position during a revolution of the rotor device. An air or steam receiving housing is provided and is adapted for mounting adjacent the rotor device and for receiving air or steam. This housing has an air or steam outlet. An air or steam conducting member has an inlet end for air or steam to enter the air conducting member and an outlet end through which air or steam flows into the housing. The conducting member forms a passage extending between the inlet end and the outlet end, this passage being mounted on one side by a circumferentially extending section of the circular cylindrical surface of the cylindrical member which is on one side of the conducting member. During operation of the rotary machine, an extended portion of each of the vanes passes through and along the passage and projects radially from the circular cylindrical surface while passing through the passage in order to fill substantially the cross-section of the passage as taken in the radial plane defined by the respective vane, whereby each vane in turn either pushes air along the air passage and into the housing so that the machine operates as an air pump or is pushed by pressurized air or steam along the passage so that the machine operates as a motor.

In an exemplary embodiment in which this machine operates as an air pump, there is an air discharge valve adapted to control flow of pressurized air through the air outlet of the air receiving housing.

These and other aspects of the disclosed continuous internal combustion engine and rotary machine will become more readily apparent to those having ordinary skill in the art from the following detailed description taken in conjunction with the drawings provided herewith.

### BRIEF DESCRIPTION OF THE DRAWINGS

So that those having ordinary skill in the art to which the present disclosure pertains will more readily understanding how to make and use the subject invention, exemplary embodiments thereof will be described in detail herein below with reference to the drawings, wherein:

FIG. 1 is a diagrammatic cross-section of an exemplary continuous internal combustion engine constructed according to the present disclosure, this cross-section being taken along a radial plane relative to the axis of rotation of the rotor of the engine;

FIG. 2 is a side view of an eccentric shaft used in the engine of FIG. 1;

FIG. 3 is an axial cross-section of the cylindrical rotor, vanes and vane control mechanism used in the engine of FIG. 1;

FIG. 4 is a cross-sectional detail view of one form of vane control mechanism which employs the eccentric shaft of FIG. 2, this view showing details on the left side of FIG. 3;

FIG. 5 is an axial cross-section similar to FIG. 3 showing a cylindrical rotor, vanes and another form of vane control mechanism, this mechanism employing solenoids;

FIG. 6A is a side view of the cylindrical rotor with portions broken away to show details of shaft supporting sleeves at each end;

FIG. 6B is an end view of the flange connector at the left end of the rotor as seen in FIG. 6A;

FIG. 7 is a perspective view of the combustor used in the engine of FIG. 1, this view showing an open side of an extension section of the combustor;

FIG. 8 is a cross-sectional detail illustrating a fuel-air injection system for the present engine;

FIG. 9A is a side view of one vane and its two supporting rods which can be used in the engine of FIG. 1;

FIG. 9B is an end view of the vane and supporting rods of FIG. 9A;

FIG. 10 is a schematic cross-sectional detail taken along a radial plane relative to the center axis of the rotor, this view illustrating a vane control mechanism employing a cam shaft;

FIG. 11 is a schematic cross-sectional detail similar to FIG. 10 but showing an alternate vane control mechanism, this mechanism employing electrically operated solenoids;

FIG. 12 is a schematic cross-sectional detail similar to FIGS. 10 and 11 but illustrating another vane control mechanism, this mechanism employing air or hydraulic cylinders;

FIG. 13 is a block diagram illustrating the fuel and air supply system which can deliver a mixture of fuel and air to the combustion chamber of the engine;

FIG. 14 is a block diagram illustrating an oil lubrication system that can be used for the present engine;

FIG. 15 is another block diagram illustrating one form of monitoring and controlling system for the present engine;

FIG. 16 is a diagrammatic cross-section of an exemplary air pump constructed according to the present disclosure;

FIG. 17 is a diagrammatic cross-section of an exemplary air or steam motor constructed according to the present disclosure; and

FIG. 18 is a block diagram illustrating how various components can be connected to the engine of FIG. 1 to form a complete power producing system, these components including the fuel and air supply system plus a heat exchanger operatively connected to the combustion chamber and the compressor.

### DETAILED DESCRIPTION OF EXEMPLARY EMBODIMENTS

Advantageous internal combustion engines and rotary machines, including air pumps and air motors, having a range of applications are disclosed herein. The described engines permit an efficient generation of power which can be provided to a rotating drive shaft, this power being produced by the combustion of a mixture of fuel and air in a combustion chamber. Also, the air pumps described herein enable an efficient generation of pressurized air which, if desired, can be provided to a pressurized air tank. The air and steam motors described herein can efficiently provide power to rotate a drive shaft from a source of pressurized air or steam.

In the detail description which follows, various exemplary embodiments are described but it will be understood that the particularly disclosed embodiments are merely illustrative of engines, rotary machines and pumps that can be constructed according to the present disclosure by one skilled in the construction of rotary and/or internal combustion engines, rotary machines, and air pumps.

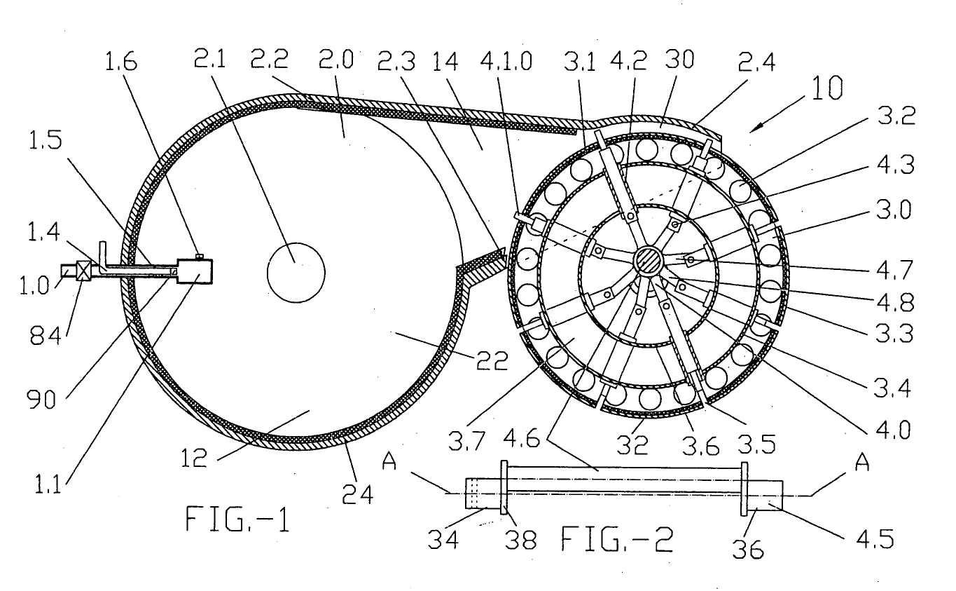

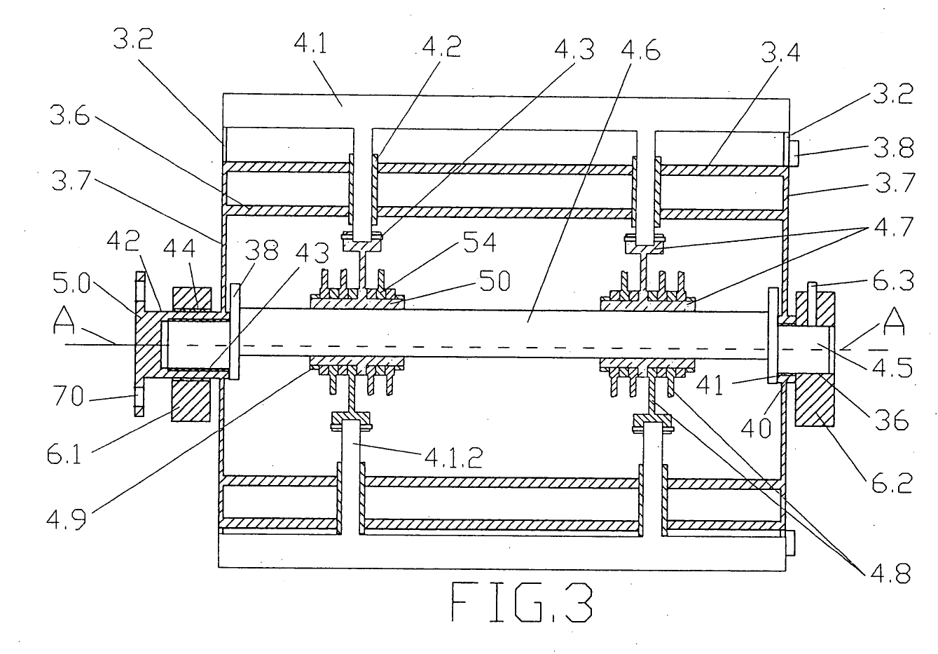

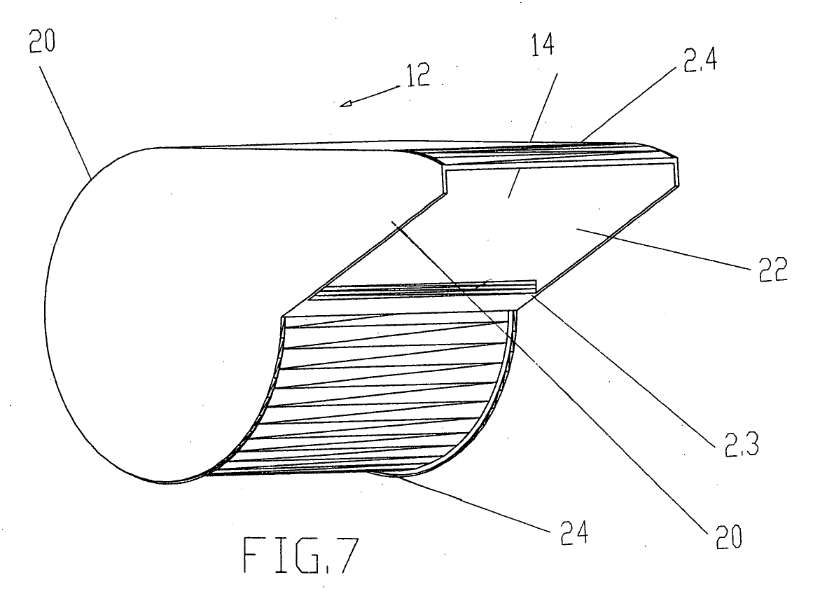

FIG. 1 illustrates a continuous internal combustion engine 10 having a combustor 12 operative to produce combustion gases in a combustion chamber 2.0. The combustor is fitted with a fuel air system 1.0 for delivering a mixture of fuel and air to the combustion chamber and an ignition device in the form of a sparker 1.6 which can ignite the mixture of fuel and air. Ignition of the fuel and air mixture in the combustion chamber produces rapidly expanding combustion gases. The illustrated combustor has a side extension 14 which can taper inwardly in a direction away from the centre of the combustion chamber. Mounted at the outer end of this side extension is a cylindrical drum or rotor device 3.0 in which there are mounted a plurality of vanes 4.1.0 which can also be described as radially extending plates. The rotor device 3.0 is mounted outside the combustor 12 for rotation about a first axis A indicated in FIG. 3, this axis corresponding to a central axis of two end sections of an eccentric shaft 4.6 on which the rotor device rotates. The combustor can have a substantially cylindrical shape except for the aforementioned side extension 14, this shape being more clearly visible in FIG. 7. The combustor is formed by two side wall plates 20, 22 and a cylindrical wall 24 that extends between and rigidly connects the two side wall plates. As illustrated, the wall 24 extends through a cylindrical arc of at least 270 degrees.

A valve 2.1 can be mounted in one of the two side wall plates 20, 22, preferably in the center of the plate as shown. This valve which can be electronically actuated is adapted to open the combustion chamber to atmosphere when an accelerator pedal for controlling the engine is not being pressed and an operator of the engine does not want engine braking. The valve 2.1 can be opened automatically by and controlled by a computer which is part of an engine control system explained further hereinafter. If the valve 2.1 is closed and there is no combustion of gases in the combustion chamber, this causes a drag on rotation of the rotor device. Because the rotor will rotate to some extent from its own inertia after combustion ceases, this rotation will draw further gases from the combustion chamber and create a vacuum which in turn will slow rotation of the rotor for reasons which will become clear from the detailed description of the rotor set out below and its operation. When the acceleration pedal of the vehicle is pressed, this will be sensed by the computer which then automatically closes the valve 2.1, allowing the pressure in the chamber to increase. It will thus be appreciated that the valve 2.1 can be used as a form of engine brake when the acceleration pedal is not being pressed and a brake pedal (when provided) is pressed. The valve 2.1 can be actuated by pressing, for example, the brake pedal in a vehicle in which the engine is operating and by not engaging the acceleration pedal and, in particular, the braking system can be set up so that the initial movement of the brake pedal actuates the valve 2.1. Preferably the valve 2.1 is closed gradually by the computer in order to obtain a smooth braking force. The final portion of brake pedal movement can then gradually actuate conventional brakes on the vehicle. It will be appreciated that such a braking system can provide the advantage of permitting the conventional brakes on the vehicle to be smaller than would otherwise be the case. In order to achieve smooth braking, the aforementioned computer can take into account the rotational speed of the rotor 3.0 and the actual speed of the car or vehicle at the time the braking is required.

A suitable support structure (not shown) for the combustor 12 is provided so that the combustor is held firmly in place, for example, on the structure such as a vehicle or car. According to the illustrated embodiment of the combustor, it is covered on its interior with suitable heat insulation 2.2 which can extend over not only the cylindrical wall 24 but also the side wall plates 20, 22. Although not shown in FIG. 1, this insulation 2.2 can even extend along an upper lip 2.4 described further below. This heat insulation acts to reduce heat loss through the walls of the combustor which in turn increases the efficiency of the engine. Although the illustrated engine has the insulating material on the inside of the metal walls forming the combustor, the layer of insulation can be on the exterior of the metal walls and indeed exterior insulation can be preferable as it is not exposed directly to the combustion. Insulation material on the interior of the combustor must withstand the heat and pressure caused by the continuous combustion in the chamber 2.0.

The side extension 14 of the combustor extends to an upper lip or extension section 2.4 which can have an arc shape in cross-section as shown in FIG. 1 and two opposite sidewalls. A discharge passage 30 for the combustion gases is formed between this extension section and a circumferentially extending section of a circular cylindrical surface forming the exterior of the rotor device.

Turning now to the construction of the rotor device 3.0, the device includes a cylindrical member with a plurality of axially extending slots 3.5 formed therein and distributed about the circumference of the cylindrical member which has an outer, circular cylindrical surface 32. Each vane 4.1.1 (see FIGS. 9A and 9B) is mounted in the rotor device for radial movement in a respective one of the slots 3.5. The rotor device has a vane supporting arrangement for supporting the vanes 4.1.1 and guiding the vanes during their radial movement. In particular, according to the illustrated embodiment of the rotor device, the device includes an intermediate cylindrical member 3.4 and an innermost cylindrical member 3.6, both of which are concentric with the cylindrical member 3.3 which is the outermost cylindrical member. All three cylindrical members are connected to two circular end plates 3.7 located at opposite ends of the cylindrical members. These end plates can be made of suitably strong metal, the same as the cylindrical members and can be welded thereto or alternatively, bolted thereto (not shown). These end plates 3.7 are rotatably mounted on a central shaft arrangement which can be in the form of an eccentric central shaft 4.5 shown separately in FIG. 2. The eccentric shaft 4.5 includes two axially aligned end sections 34 and 36 and these end sections are coaxial with the aforementioned first axis A. Connected to each end section is a small shaft connecting plate 38 which can be circular or rectangular. Extending between the two plates 38 is an eccentric section 4.6 of the eccentric shaft having a central axis parallel to but offset from the axis A. The eccentric section 4.6 is substantially longer than the end sections 34, 36. Each end plate 3.7 is formed with a central hole to receive a respective one of the shaft end sections. Mounted on one end plate 3.7 is a short, circular sleeve 40 while mounted on the other end plate 3.7 at the central hole is a sleeve 42 which is part of a drive coupling member 5.0, and each of these sleeves can have respective bushings 41, 43 mounted therein to reduce friction. The internal diameter of the bushings corresponds closely to the diameter of their respective shaft end sections 34, 36. The rotor device is rotatably supported by means of the two sleeves 40, 42, a left side bearing block 6.1 (as seen in FIG. 3), and a right side bearing block 6.2. The sleeve 42 extends through the bearing block 6.1 and a bushing 4.4 as shown while sleeve 40 is rotatably mounted on the eccentric shaft at an inner side of the bearing block 6.2. It will be understood that the bearing blocks can be of standard construction and are of sufficient size and strength to support the weight and movement of the rotor device. Each bearing block is rigidly connected to a suitable support frame (not shown) such as frame members of a vehicle. A suitable stop member is provided to prevent rotation of the eccentric shaft 4.5. One form of stop is a holding pin 6.3 which extends radially into the end section 36 and which can be held against movement and rotation by a fixed section of the bearing block 6.2 or a separate mounting block adjacent the block 6.2. In the alternative, the end section 36 of the shaft can be splinted and thereby held against rotation by a fixed connection to a suitable holding block.

Turning now to the manner in which each vane is mounted for sliding movement in the rotor device, a single vane assembly apart from the rotor is illustrated in FIGS. 9A and 9B. Each vane 4.1.1 is rigidly mounted along the centre of an optional reinforcement plate 4.1.3 which can extend substantially the entire length of the vane. By using this reinforcement plate, the rigidity of the vane is increased. Located on the side opposite the vane 4.1.1 are two straight sliders or rods 4.1.2. One end of each rod is attached such as by welding or other known attachment methods to the reinforcement plate. The two rods extend parallel to one another, are spaced apart from each other and are spaced from their respective ends of the vane 4.1.1. Although the movement of the vanes can be controlled in several different ways as explained hereinafter, the distance D between the two rods 4.1.2 is different from the same distance D for the rods of another vane in the rotor except that the distance D between the rods of diametrically opposite plates 4.1.1 can be the same in some versions of the engine. The reasons for the difference in the distance D is to prevent contact between connecting rods 4.1.1 (see embodiment of FIG. 11) or main or auxiliary rods 4.7 and 4.8 (see below). Although the distance D between the rods varies, the two rods of each vane are positioned the same distance from their respective ends of the vane. Each rod is slidably mounted in a cylindrical bushing or sleeve 4.2 which acts to constrain vane movement to a radial movement. Each bushing is rigidly mounted in a suitable hole formed in each of the innermost cylindrical member 3.6 and intermediate cylindrical member 3.4. The bushings are suitably lubricated by oil under pressure with the oil lubrication system being illustrated in FIG. 14.

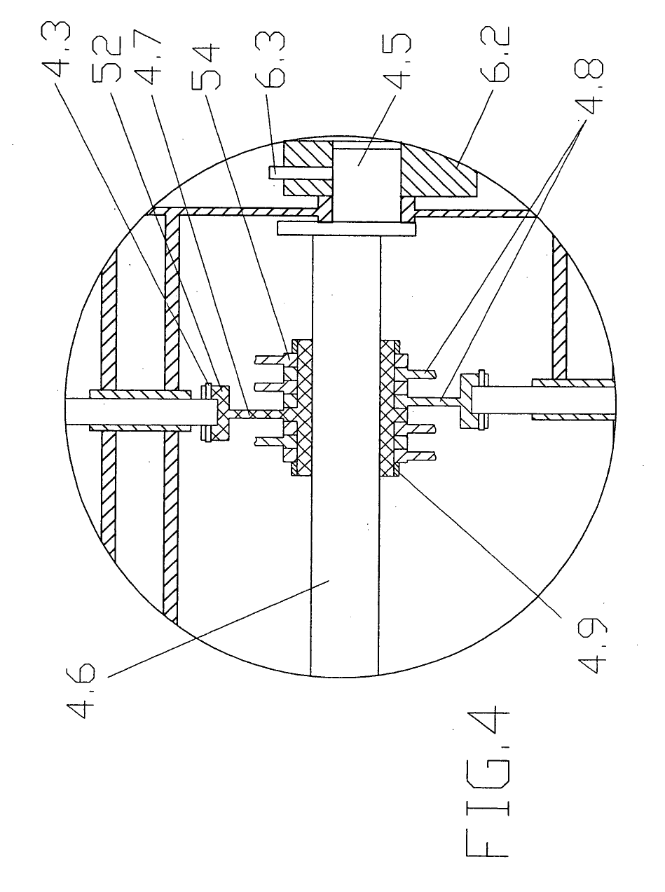

The present continuous combustion engine has vane control means for moving each of the vanes 4 between a fully extended position where each vane projects beyond the circular cylindrical surface of the rotor a maximum distance and a fully retracted position during a revolution of the rotor device. As described herein, there are several different alternative arrangements that can be used for controlling vane movement in the radial direction and one of these control mechanisms is illustrated in FIGS. 3 and 4. This control mechanism employs the aforementioned eccentric shaft 4.5. Each rod or slider 4.1.2 is connected to another pivoting and rotating rod which can be in the form of either a main rod 4.7 or an auxiliary rod 4.8 with both types being illustrated in FIGS. 3 and 4. The main rod is rigidly connected to a bushing or sleeve 50 that extends around the eccentric section 4.6 of the eccentric shaft. At the end opposite the sleeve is a connecting section or clevis 52 which is pivotably connected to the inner end of its respective rod 4.1.2 by means of pivot pin 4.3. Each pin 4.3 can be held in place by a friction or force fit in the connecting section 52 or by other known fastening methods.

The auxiliary rods do not have a bushing or sleeve 50 but instead each of these rods is formed with a connecting ring 54 that rides on the sleeve 50 and that is able to pivot relative thereto as shown in FIG. 1. Thus the ring 54 acts like a rotatable sleeve but is narrower. As shown in FIG. 3, the two main rods 4.7 are pivotably connected to the same vane 4.1.1 and, in a similar manner, two auxiliary rods 4.8 are connected to a respective one of the other vanes. The outer rings 54 on each sleeve 50 are held on the sleeve by means of an annular stopper 4.9, each of which can be held in place by a set screw or similar threaded connector. It will be appreciated that both the main rods and the auxiliary rods are lubricated by the oil which is circulated under pressure by the oil lubrication system illustrated in FIG. 14. It will be seen that the main rods 4.7 undergo a full rotation about the eccentric shaft when the rotor rotates 360 degrees. The centrifugal forces in the sleeve of the main rod are almost balanced because the various centrifugal forces which act on this sleeve are, to a significant extent, balancing each other. On the other hand, the auxiliary rods 4.8 which are also subject to centrifugal forces are only required to rotate a fraction of a full rotation relative to the sleeve 50 on which they are mounted, this fraction being determined by the relative difference between the position of the annular ring of the auxiliary rod and the sleeve 50 on which it is mounted during rotation of the rotor and it will be appreciated that this relative difference is much less than one full rotation. Due to this construction, there is less friction due to relative movement, less heat build up within the rotor, and engine efficiency increases. This particular construction for the vane control mechanism which employs an eccentric shaft can operate well at high RPM's. The other vane control mechanisms described hereinafter are suitable for lower maximum RPM engines, for example, those constructed to operate at a maximum RPM of 10,000 or less.

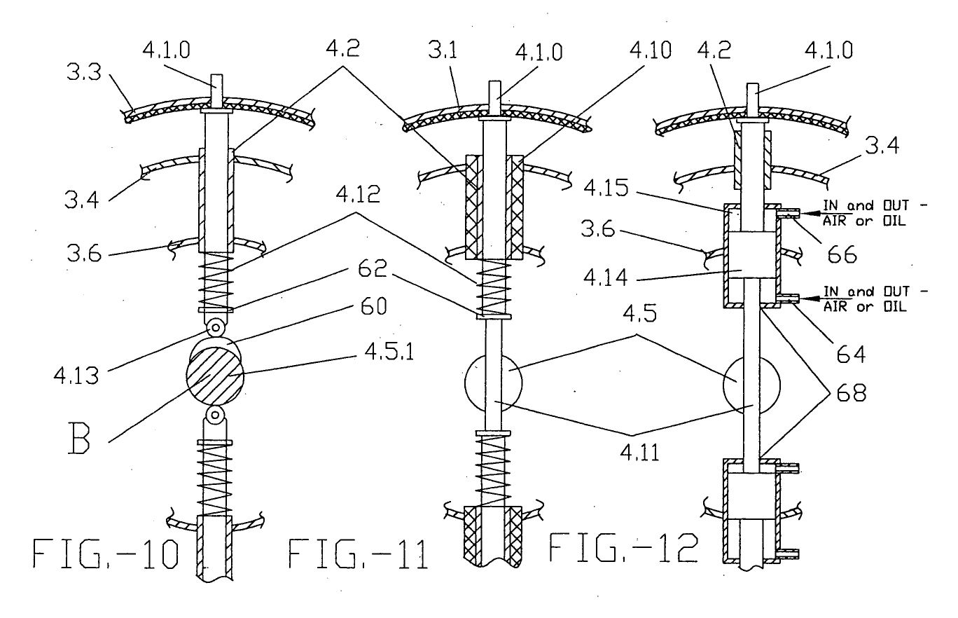

A first alternative vane control mechanism is illustrated schematically in FIG. 10, this mechanism employing a fixed cam shaft 4.5.1 which has a center axis indicated at B and which is mounted at each end in bearing or support blocks, for example, in a manner similar to the eccentric shaft shown in FIG. 3. Two cam surfaces 60, one for each rod 4.1.2, are formed on the cam shaft. At the inner end of each rod or slider 4.1.2 is a roller 4.13 and it will be understood that there are two rods with respective rollers 4.13 for each vane 4.1.1. Engagement between each roller 4.13 and its respective cam surface causes the vane to move radially outwardly as required during rotation of the rotor. Also, mounted on each rod 4.1.2 is a coil spring 4.12 which acts to bias the rod radially inwardly so that engagement between the roller and the cam surface is maintained. The outer end of the spring presses against the inner end of the bushing 4.2 while the inner end of the spring engages a circular flange or collar 62 formed or fitted on the rod as shown. An engine using this type of vane control mechanism can be made less expensive than the engine of FIGS. 1 to 4 and it provides the required radial movement of the vanes in a reasonably simple manner. However, a vane control mechanism of this type can be less advantageous when the rotor is rotating at high RPM's because the vanes can start to float, i.e. their respective rollers can become disengaged from the cam surface 60. When this occurs, damage or wear on the engine can take place and the engine can lose power because of the need to overcome friction caused by the floating plate or plates and this decreases the efficiency of the engine. However, an engine constructed in this manner can operate efficiently at lower RPMs.

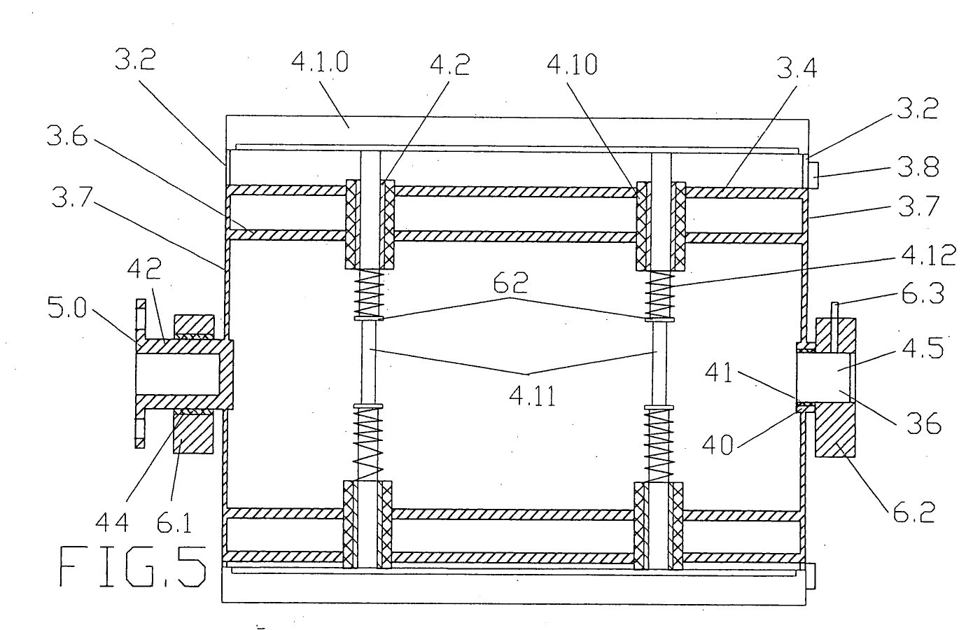

Another alternative vane control mechanism is illustrated in FIGS. 5 and 11. In this embodiment, at least one rod for each vane, and preferably both rods, are fitted with an electrically operated solenoid 4.10 which can take the form of a sleeve member extending around the bushing 4.2. There can be mounted at the inner end of the bushing an optional coil spring 4.12, the inner end of which presses against the collar 62. Each spring biases its respective vane radially inwardly. Electrical conductors (not shown) are connected to each solenoid in order to power same. Each solenoid is connected to two wires which extend through the drum or rotor to the sleeve 40 where the end of each wire is attached to a graphite brush (as used in electric motors). The two solenoids 4.10 for each vane are electrically connected in series and are powered through the same brushes. The two brushes are spaced axially from one another on the sleeve 40 so that, for example, the left side brush can be positive and the right side brush can be negative or vice versa. The brushes for all the vanes ride on two conducting rings mounted on the end section of shaft 4.5. The rings are split into two sections for each so that, during one half of a rotation of the rotor, the contacted section of the ring on the left side is positive and the contacted section of the ring on the right side is negative. During the other half of the rotor's rotation, the contacted section of the left ring is negative while the right ring is positive. The rings are connected to a power source such as a battery. When the rotor rotates, the polarity is arranged so that the two solenoids for each vane in the gate area act to draw the vane outwardly. However, for vanes moving away from the gate area, the solenoids act to pull the vanes inwardly. If used, the coil springs 4.12 can help overcome the inertia of their respective vanes when they change their direction of radial movement. However, such a vane control mechanism can also be made with none of the springs 4.12. An engine with this type of vane control mechanism can be more expensive to construct and again, the vanes can start floating when the engine is operating at high RPM's. Another disadvantage of this particular engine is that electrical energy is required to move the vanes outwardly, thereby lowering the efficiency of the engine. One advantage of this type of engine is that the radial movement of the vanes can be relatively easy to control at lower RPM's. It will be readily apparent to those skilled in the construction of electrical machines that there are other ways of electrically controlling the movement of vanes in the rotor. The sleeve 42 is mounted on the bearing block 6.1 so that the sleeve 42 can rotate freely and easily. The short shaft section 36 is fixedly mounted in the block 6.2 and the sleeve 40 is rotatably mounted on the shaft section 36.

With the embodiment of FIGS. 5 and 11, it is also possible to balance the centrifugal forces acting on the vanes by using a central connecting rod 4.11 which joins together the inner ends of the rods 4.1.2 of opposite vanes. In other words, this connecting rod can extend between two flanges or collars 62. It will be understood that the connecting rods for vanes which are not diametrically opposed to one another are positioned at different locations along the central axis of the rotor. It will be understood that the use of the rods 4.11 can reduce substantially the necessary forces for maintaining the vanes in the required radial position since the centrifugal force acting on each vane is largely offset by the centrifugal force acting on the diametrically opposite vane. Furthermore, this construction permits two of the electrical solenoids 4.10 to be used to move two connected vanes and this in turn means that the magnetic force generated by each solenoid can be less and the size of each solenoid can be reduced.

A third alternate construction for the vane control mechanism is illustrated in FIG. 12. This system employs a fluid operated piston 4.14 mounted on each rod 4.1.2 of each vane 4.1.1. Each piston is radially movable in a cylinder 4.15 which can be rigidly mounted in the innermost cylindrical member 3.6. In this case, each bushing 4.2 can be shorter than in the other embodiments and can be supported solely by the intermediate cylindrical member 3.4. The piston can be moved in its cylinder either by pressurized air or pressurized oil which can enter or exit opposite ends of the cylinder through ports 64 and 66. A pneumatic or hydraulic control system (not shown) can be used to deliver air or oil to either end of the cylinder 4.15 as required for radial movement of the vane. Unless each piston is connected to an opposite piston as described hereinafter, the inner end of the cylinder 4.15 can be closed while the rod 4.1.2 extends through the opposite end of the cylinder in a sealing manner. A hydraulic or pneumatic vane control system can be set up to operate in a manner analagous to the above electrically controlled vanes. For example, oil or air pipes or lines are used in place of electrical wires. Grooves can be provided in the rotating sleeve instead of ring conductors and these grooves are sealed off by means of oil or air seals. In a hydraulic system, the oil source can be an oil accumulator, but in a pneumatic system, the pressurized air source is an air tank. With respect to this particular vane control mechanism, its advantages and disadvantages are similar to those described above in connection with the vane control mechanism employing electrical solenoids. A rotor employing this form of vane control mechanism can be mounted on rotating shaft sections similar to the sections 36, 42 shown in FIG. 5 and at least one of these shaft sections can be made hollow in order to permit pressurized air or pressurized oil lines to be run into the central passageway of the shaft section.

Again, with the vane control mechanism of FIG. 12, it is possible to rigidly connect together opposing pistons 4.14 by means of a straight connecting rod 4.11 in order to balance the centrifugal forces acting on the opposing vanes. These connecting rods extend through respective openings 68 formed in the inner ends of the cylinders 4.15. Around the opening 68 are provided suitable air or oil seals to prevent leakage of air or oil from the cylinders. Although it is possible to construct such a vane control mechanism using only one piston and cylinder for each diametrically opposed pair of vanes, by using two piston/cylinder combinations, the amount of radial force required from each combination is reduced and thus the size of the piston/cylinder combination can be smaller than would be the case if only a single piston/cylinder is used.

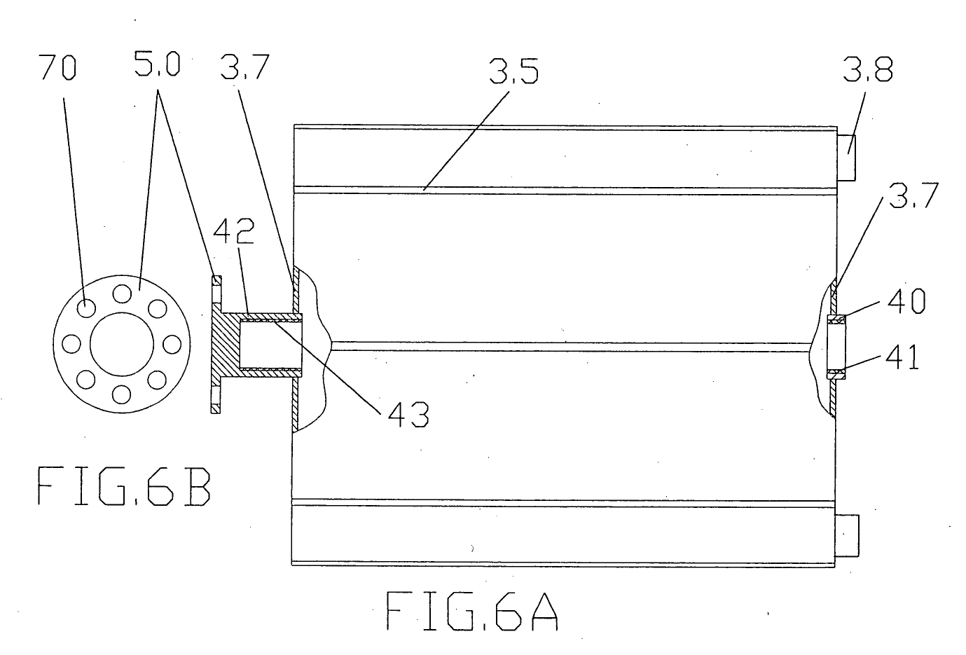

The present invention can be provided with a drive coupling member 5.0 mounted centrally on the exterior of one of the end plates 3.7 of the rotor. Such a coupling member is shown in FIGS. 3, 5 and 6A and an end view of the coupling member is shown in FIG. 6B. The coupling member can take the form of an end flange formed on the outer end of sleeve 42. This coupling member provides means for operatively connecting the rotor device to a transmission (not shown) which can, for example, be an automobile transmission. The illustrated coupling member is formed with a series of fastener holes 70 which can be used to connect it to a drive shaft, for example. Suitable nuts and bolts can be used to join the coupling member to the drive shaft. Possible alternative forms of couplings include a spine type connector and other known types of connectors that can transfer torque.

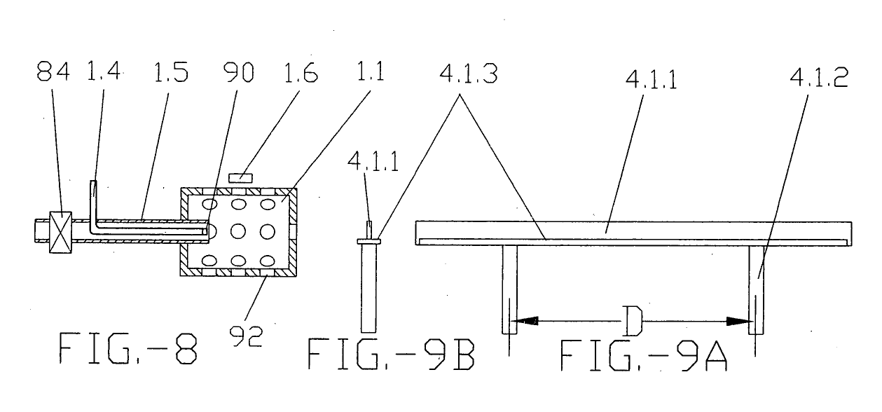

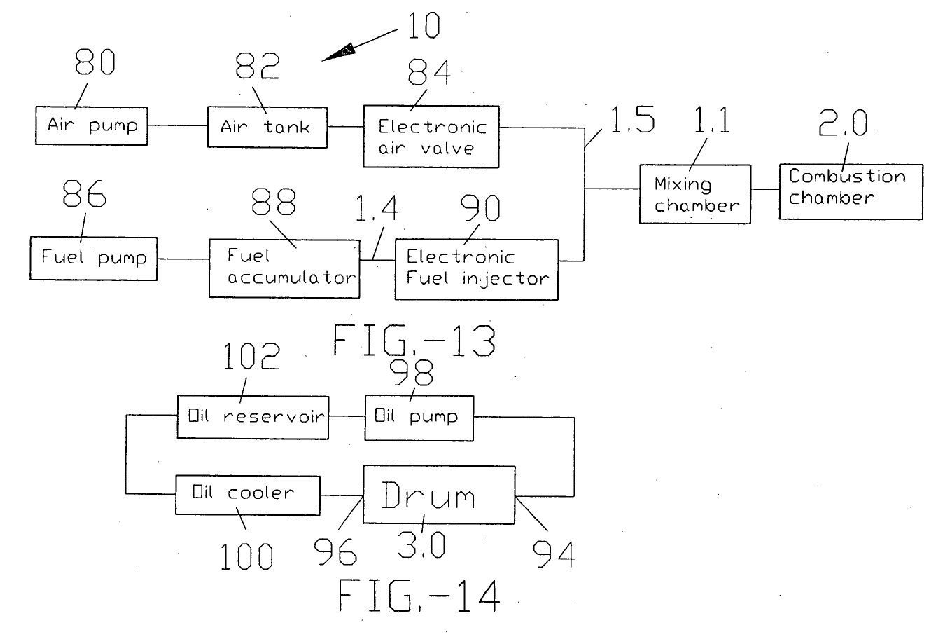

With reference now to FIG. 13 which diagrammatically illustrates one version of air and fuel supply system for the present engine, an air pump or compressor 80 can be driven by the output drive shaft of the present engine. This air pump, which can be constructed either in the manner of the air pump of this invention (described below) or of conventional construction, pumps air into an air tank 82. From this tank, pressurized air is supplied through a suitable air tube 1.5 (see FIG. 1 and FIG. 8) to mixing chamber 1.1. This pressurized air is provided by and controlled by an electronically controlled air valve 84. The air valve can for example be controlled by a microprocessor or similar computer device which controls overall engine operation. The illustrated fuel and air supply system includes a fuel pump 86 which can also be driven by the output drive shaft connected to the present engine, which pump can also be of standard construction, if desired. The pump pumps fuel to a fuel accumulator 88 from which fuel is supplied through the fuel tube 1.4 (see also FIGS. 1 and 8) using an electronically controlled fuel injector 90 to the mixing chamber 1.1. In this chamber, the fuel is mixed with the air supplied by the air pump. The mixing chamber can have a number of holes 92 distributed over its surface through which the mixture of air and fuel passes into the combustion chamber of the engine. After the mixture has entered this combustion chamber, a sparker 1.6 is able to ignite the air-fuel mixture. It will be understood that the fuel and air supply system is capable of providing the desired pressurized mixture in the mixing chamber 1.1 and then to the combustion chamber 2.0.

FIG. 14 illustrated diagrammatically how the rotor device 3.0 and the mechanical linkage mounted therein are lubricated and how the mechanical linkage and rotor can be cooled. In particular, the rotor device or rotary drum 3.0 is fitted with both an oil inlet 94 and an oil outlet 96, both of which access the interior of the innermost cylinder 3.6 which contains the central shaft and the mechanical linkage. An oil pump 98 is operatively connected to the oil inlet 94 and thus provides oil to lubricate the various connecting points and sliding and rotational bushings found in the rotor device. In one version of the oil circuit, there is an oil cooler 100 which can be a suitable standard heat exchanger constructed for this purpose and which can be operatively connected to the outlet 96 of the drum. The oil cooler is adapted to cool lubricating oil which has been heated by operation of the engine. Operatively connected between the oil cooler and the oil pump can be an oil reservoir 102. The oil pump is connected to draw oil from the outlet of the oil reservoir. Instead of using the oil reservoir, it is possible to use the innermost cylinder 3.6 to hold additional oil over and above that required to operate the oil circulating system. As a further alternative, it is possible to locate the oil pump inside the drum 3. Furthermore, instead of having a separate oil cooler, it will be appreciated that the drum 3.0 in itself can be constructed to assist in the cooling of oil circulating therethrough.

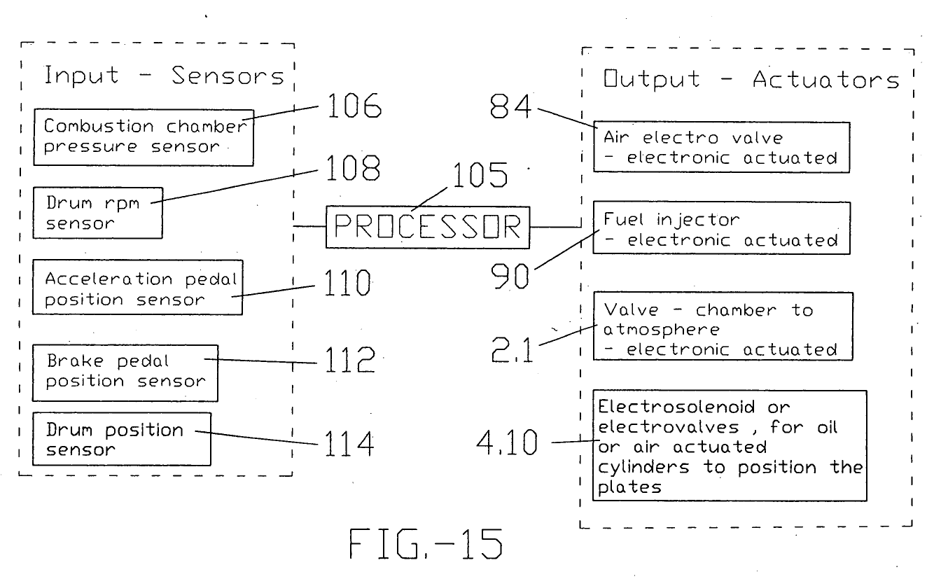

FIG. 15 illustrates diagrammatically how the described internal combustion engine can be electronically controlled. In particular, the engine and/or vehicle in which the engine is mounted can be fitted with the following input sensors which are operatively connected to a suitably programmed microprocessor 105;

(a) A combustion chamber pressure sensor 106 adapted to monitor the pressure in the combustion chamber;

(b) A sensor 108 for monitoring the revolutions per minute (RPM) of the drum or rotor 3.0;

(c) A pedal position sensor 110 in order to provide electrical signals to the microprocessor which are indicative of the level of acceleration desired by the user;

(d) A brake level position sensor 112 which is able to provide an electrical control signal indicative of the level of braking, if any, required for the vehicle; and

(e) A drum position sensor 114 which can be used with the vane control mechanism shown in FIG. 11 (that is a mechanism using electrical solenoids) or the vane control mechanism of FIG. 12 (that is the one using air or oil operated cylinder/piston mechanisms) since in these particular versions of the engine, it is desirable to know the position of the rotor or the drum at all times during engine operation in order to properly operate the vane control mechanism.

In addition to these sensors for the engine, it will be appreciated by one skilled in the art that additional sensors can also be used if desired in order to measure various conditions or situations that can affect engine operation. The processor 105 or other programmable computer also receives the various input signals from the aforementioned sensors, processes these inputs, and is then able to control different systems, components, or actuators of the engine including the following:

1. The electronic air valve 84 used to control the amount of pressurized air delivered to the mixing chamber;

2. The solenoid of the fuel injector 90 used to control the amount of fuel delivered to the mixing chamber;

3. The valve 2.1 (electrically actuated by a solenoid) in the side of the combustion chamber which is able to open or close the combustion chamber to the atmosphere.

4. The electrical solenoids 4.10 used to control the movement of and position of the vanes in the embodiment of FIG. 11;

5. Electrical solenoids used to control the oil or air actuated cylinder/piston combinations used to displace and control the position of the vanes in the embodiment of FIG. 12.

In addition to these engine components, it will be appreciated that it is also possible to use the microprocessor 105 to control other components or features of the engine or the vehicle driven by the engine.

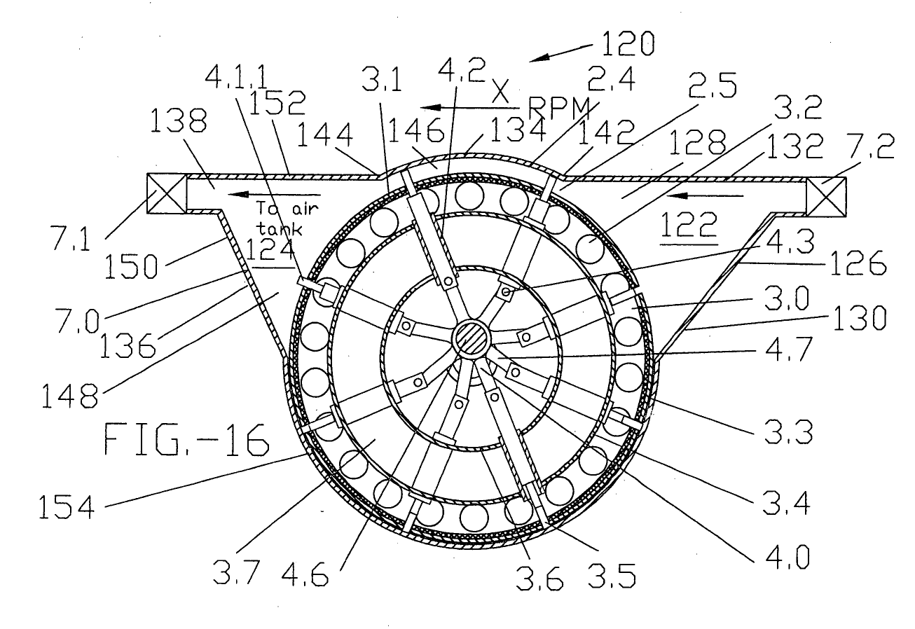

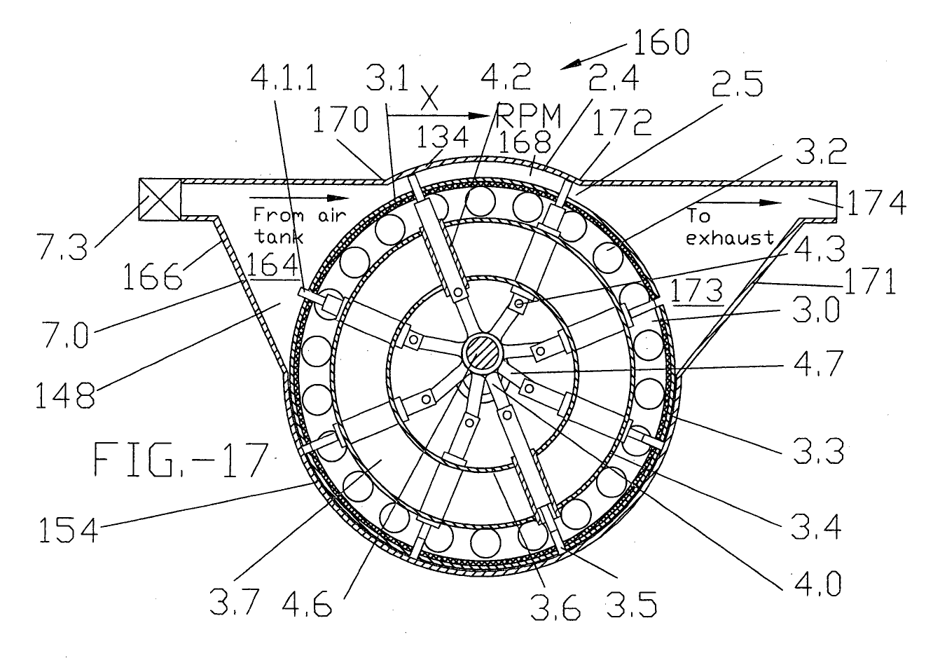

FIG. 16 illustrates an exemplary embodiment of an air pump constructed in accordance with the present disclosure. This air pump 120 has many features and components in common with the above described internal combustion engine and only the differences between the air pump and the engine will now be described. The same reference numbers are used in FIG. 16 to indicate components and parts which are the same as those in the engine of FIGS. 1 and 3. Of course, in the case of the air pump, there is no need for a fuel and air system 1.0. Also, instead of a combustion chamber, there can be two air chambers 122 and 124 which, as shown, are of similar size and shape. Air is drawn into the air pump through an air filter 7.2 which is mounted at the inlet to the air chamber 122 which can be formed by housing section 126. The air chamber 122 is defined by a portion of the cylindrical surface of the rotor and the walls of the housing section 126 which include two side walls 128 of substantially triangular shape and connecting walls 130 and 132 that extend between the side walls and converge on one another in the direction of the filter 7.2. An arc-shaped air conducting member 134 extends along a portion of the circumference of the rotor to an air receiving housing 136 which defines the air chamber 124 which is closed along one side by a portion of the cylindrical surface of the rotor. The housing 136 is adapted for mounting adjacent the rotor and for receiving and contained pressurized air and this housing has a pressurized air outlet 138 which can be connected to a discharge valve 7.1 which permits airflow only out from the chamber 124.

The air conducting member 134 forms an enclosed air passage that extends from an inlet end 142 for external air to enter the air conducting member and an outlet end 144 through which air flows into the chamber 124 and housing 136. It will be understood that in this air pump, the air is pumped into the housing 136 by the rotor device 3.0 and the vanes 4.1.1 and again, the air passage 146 formed by the air conducting member 134 is bound on one side by a circumferentially extending section of the circular cylindrical surface of the cylindrical member which forms the exterior of the rotor.

Like the housing section 126, the housing 136 is formed by two opposite side plates 148 and two converging connecting plates 150 and 152. Plate 152 is connected to the air conducting member 134 while the plate 150 extends to a point along the circumference of the rotor. The two side plates 148 are in close proximity to the respective end plates of the rotor. A curved, rotor enclosing plate 154 extends between the connecting plates 150 and 130 and is in close proximity with the cylindrical exterior surface of the rotor.

In use of this air pump apparatus, the air outlet 138 can be connected to a pressurized air tank via the discharge valve 7.1. It will be understood that the valve 7.1 is constructed to open when the air pressure within the air chamber 124 reaches a level higher than the air pressure maintained in the air tank. The rotor of this air pump can be driven by a suitable engine of the type described herein and connected to the rotor coupling member 5.0 of this engine. In the alternative, a standard internal combustion engine can be used to drive the air pump.

FIG. 17 illustrates another form of rotary machine constructed in accordance with the present disclosure, this rotary machine being an air or steam motor indicated generally at 160. This motor can be similar in this construction and operation to the above described air pump and it will be understood that the rotor 3.0, the vanes 4.1.1 and the vane control mechanism can be similar to or the same as those in the internal combustion engine of FIGS. 1 and 3. In the case of the motor 160, pressurized air or steam is supplied to the motor from an air tank (not shown) which acts as a source of pressurized air or a source of steam such as a boiler. The pressurized air or steam passes through a control valve 7.3 which ensures that air or steam flows only into an air chamber 164 which can be similar in size and shape to the above described air chamber 124. This chamber is defined by housing section 166 and a portion of the cylindrical exterior of the rotor. The chamber 164 feeds air or steam to a passage 168 which is bounded by conducting member 134 and a portion of the cylindrical exterior of the rotor. The member 134 has an inlet end 170 for pressurized air or steam to enter the conducting member and an outlet end 172 through which air or steam flows into a housing section 171 which forms an air chamber 173. It will be understood that in this motor, the vanes 4.1.1 within the passage 168 are pushed by the pressurized air or steam along the passage, thereby causing the rotor to rotate. The rotor 3.0 of this machine rotates in clockwise direction as seen in FIG. 17, this direction being indicated by the arrow X. The air or steam in the chamber 173 can be exhausted to atmosphere through air outlet 174.

In the embodiment of the engine illustrated in FIGS. 1 and 3, the length of the discharge passage 30 is approximately equal to the circumferential distance between two adjacent vanes 4.1.1 and preferably the length is slightly longer than the distance between the adjacent vanes and as a result of this distance relationship, a following vane will enter into the inlet end of the gate just prior to the preceding plate exiting from the gate, thereby ensuring no loss of compressed combustion gases without useful rotational force being exerted on the vanes. In addition, the distance that the compressed combustion gases must travel through the restricted discharge passage 30, that is the gate, is kept as short as possible (taking into account the distance between the adjacent vanes) in order to lose as little energy as possible to air friction and thereby maximize energy efficiency.

With respect to the vane control mechanism for the engine of FIGS. 1 and 3, in an exemplary embodiment of this engine, the position of the vane as it passes the lower lip 2.3 is just below the outer surface of the rotor or drum and in close proximity to this outer surface. The outer extremity of the vane should not touch the lip 2.3 as the vane enters the combustion chamber but it is desirable for the outer extremity to be close to the exterior surface of the rotor so that compressed combustion gases will not be lost at the lower lip resulting in a loss of energy. Also in the region of the gate, the vane control mechanism should extend the vanes to a maximum extent in order to ensure maximum pushing force of the combustion gases on the vanes in the gate. This pushing force is almost perpendicular to the surface of the vane in an engine where an eccentric central shaft is used and is perpendicular in other embodiments of the engine wherein the alternative vane control mechanisms are used i.e. those illustrated in FIGS. 5 and 10 to 12. The strike angle of the combustion gases on the vanes ensures maximum torque is obtained. Also, in the region of the gate, the vanes should be located as close as possible to the inner cylindrical surface of the upper lip 2.4 so that the amount of compressed gases bypassing the vanes at their outer extremities is minimized. However, the outer extremities of the vanes in the region of the gate should not touch the inner cylindrical surface of the upper lip thereby avoiding frictional contract which can cause possible overheating and possible damage to the engine. By avoiding this frictional contact, again engine efficiency is maximized, particularly at high engine RPMs. For the same reason the vanes at their opposite ends are in close proximity with the two side plates of the upper lip 2.4 and with the adjacent edges of the rotor forming the respective slots for the vanes. Again, this close proximity helps to prevent loss of pressurized combustion gases in these regions of the engine. It is also advantageous to have no frictional contact in these regions where no lubrication is provided. Although there is frictional engagement of components of the vane control mechanism, this engagement occurs in cooler regions of the rotor and, in these cooler regions, oil lubrication can be provided as described above. For purposes of this description, the term “close proximity” and equivalent terminology used to describe the relationship between engine components should be understand as indicating a clearance or separation as small as machine tolerances permit and no more than a few thousandths of an inch. In particular, the total clearance or net surface area through which combustion gases can potentially escape in a non-productive manner should be significantly smaller than the effective cross sectional area of the discharge passage 30 in the gate in order to achieve excellent efficiency.

It will be understood that when the internal combustion engine 10 is used, particularly in a vehicle, its operation can be controlled by an acceleration pedal (not shown). Fuel is supplied to the mixing chamber when the acceleration pedal is depressed and the amount supplied is dependent upon the position of the pedal. Thus, if the pedal is depressed less, the amount of air and fuel delivered to the mixing chamber will be less and vice versa. If there is no depression of the pedal at all, then no air and fuel are delivered to the mixing chamber. As indicated, this delivery of air and fuel to the mixing chamber can be computer or microprocessor controlled.

It will also be understood that the combustion of the fuel-air mixture in the combustion chamber of the engine causes the engine to act like a high pressure accumulator whereby the pressure of the burning gases is determined by the resistance to rotation of the rotor, in other words torque resistance. Thus if resistance increases at the wheels of the vehicle being driven by the engine, the torque resistance also increases and, in order to overcome this torque resistance, the pressure in the combustion chamber increases. The various parameters of the engine, including its vanes, its displacement i.e. the height of each vane in the gate area multiplied by the length of the plate which equals the area on which the gas pressure acts in the gate area, and the combustion chamber are calculated so that the maximum pressure acquired in the combustion chamber is always less than the pressure in the air supply tank, a relationship required to supply pressurized air to the combustion chamber from the air tank. Thus if the maximum operating air pressure in the air tank is 150 psi, then the maximum operating pressure in the combustion chamber can be designed to be substantially less, for example a maximum of about 100 psi.

In the exemplary embodiment of FIG. 1, the rotor device 3.0 has a heat insulation layer 3.1 on the inner surface of the outermost cylinder 3.3, this layer being provided to reduce heat loss from the combustion chamber, thereby increasing the efficiency of the engine and avoiding overheating of the lubricating oil in the rotor. Also, in order to dissipate heat that may be transmitted through the small clearance gaps between the vanes 4.1.1 and their respective slots in the rotor and in order to prevent the escaped combustion gases that pass through these small gaps from entering the interior of the innermost cylinder 3.6 where the lubricating oil is located, there can be provided side holes 3.2 in the end plates of the rotor. The provision of these holes, which are preferably provided in both end plates, permits air to circulate between the intermediate cylinder 3.4 and the outermost cylinder. In addition, there can be provided on one side of each hole 3.2 a fan blade 3.8 (see FIG. 3) which causes ambient outside air to circulate between the outermost cylinder and the intermediate cylinder, thereby reducing the possibility of overheating of the engine and in particular overheating of the lubrication system, including the lubricating oil.

Bushings 41, 43, 44 can be provided at each end of the drum or rotor in order to mount the drum or rotor on the central shaft 4.5. These bushings can be lubricated by pressurized oil. Further, if the fuel that is being used in the engine such as gasoline or diesel produces noxes as a result of combustion, a secondary form of exhaust can be added in order to reduce the emissions to a conventional exhaust system. However in engines of the present disclosure wherein the fuel being burned is natural gas or hydrogen, gases which do not produce noxes from combustion, such a secondary exhaust system is not required. Generally, however, because the pressures in the combustion chamber of the present engine are much lower than in a conventional internal combustion engine and the temperature at which the fuel is burned is lower, the amount of noxes produced will be much less.

It will be appreciated that the curved inner surface of the upper lip 2.4 of the present engine is constructed so as to closely follow the movement of the extremity of each vane passing through the discharge passage. Each vane passing through the discharge passage is only momentarily at its fully extended position before it begins to gradually retract from this position. Because of this fact, the radial distance of the upper lip 2.4 from the opposing cylindrical surface of the rotor varies along the discharge passage and in this way each vane as it passes through the passageway remains in close proximity to the inner surface of the upper lip. This construction of the upper lip is true when an eccentric shaft is used in the engine. However, when other types of vane control mechanisms (which are described above) are used, the curved inner surface of the upper lip can be a true circular arc. Because the engine of the present disclosure has good efficiency over a wide range of RPM speed it may be possible to avoid the need for a transmission to be connected to the engine output. For some engine applications, it may be sufficient to provide simply a speed reduction unit and/or a unit to reverse the direction of rotation not provided by engine output. For example, a torque converter with centrifugal lock up can be coupled to the engine and this can be coupled to a planetary speed reduction unit that provides a reversing capability. With the use of the present engine in a vehicle, it is possible to construct the drive system of the vehicle to provide a very efficient acceleration and deceleration of the vehicle, making the vehicle very efficient for use in a city or urban environment.

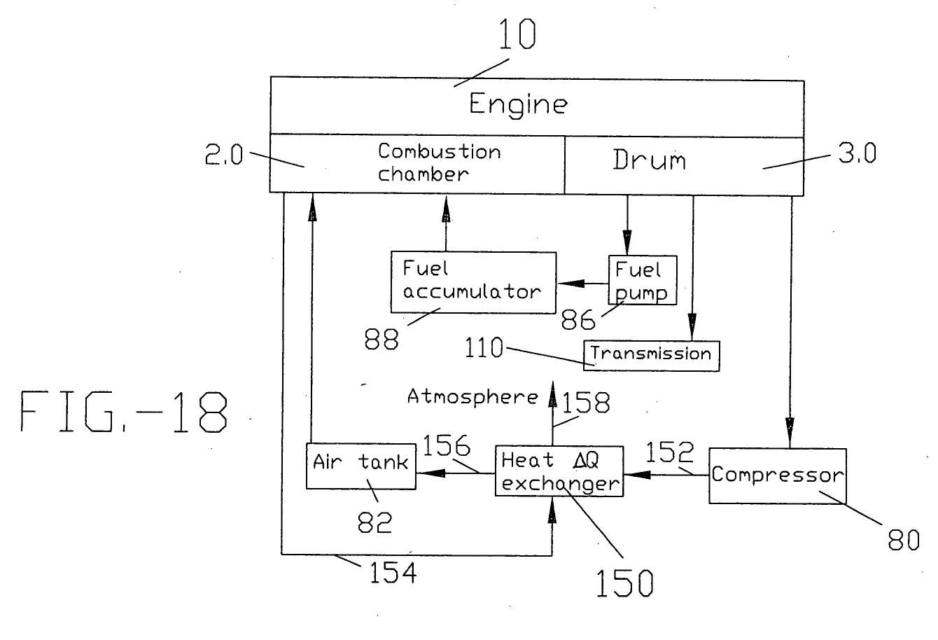

FIG. 18 is the schematic block diagram illustrating how various components including a heat exchanger can be connected to the engine of the present invention to provide an energy efficient power source. As illustrated in FIG. 18, the engine itself includes the combustion chamber 2.0 and the drum or rotor device 3.0. As explained above, a fuel pump 86 delivers fuel to a fuel accumulator 88 which in turn delivers fuel to the combustion chamber by means of an electronic fuel injector (see FIG. 13). At the same time, pressurized air is provided to air tank 82 by means of the compressor or air pump 80. Both the fuel pump and the compressor 80 can be driven by the rotating drum or rotor 3.0 which can also provide power input to a transmission 110, which can be a standard vehicle transmission if the engine is being used to power a vehicle.

In order to increase the efficiency of this power system, a suitable heat exchanger 150 can be employed, this heat exchanger receiving incoming air from the compressor indicated by arrow 152. Heated air from the combustion chamber is fed to the heat exchanger through pipe 154. The heated air goes to the air tank 82. The arrow 156 represents a pipe delivering the heated air to the inlet of the air tank. The arrow 158 represents the combustion gases which have been cooled in the heat exchanger and are exiting from the heat exchanger. The heat exchanger itself can take various forms and gas-to-gas heat exchangers are well known in the heat exchanger art. Accordingly, a detailed description of the heat exchanger herein is deemed unnecessary. The gases can pass through tubes made from material having high heat conductivity. If desired, the exhaust gases which enter the heat exchanger can be used to heat a liquid such as water which has good heat transfer properties and which is held in a surrounding container. Heat conductive tubes for the exhaust gases can pass through the liquid and its container, thereby heating the liquid, which can in turn heat the air being delivered by the compressor. The heat exchanger housing can itself be insulated as can such additional components in the system as the compressor and the air tank in order to minimize heat transfer to atmosphere by this power generating system.

It will be understood that it is possible to construct the engine described herein so that it can range in size from very small to very large and thus it can be used in a variety of vehicles including not only cars but motorcycles and boats.

It will be appreciated by those skilled in the construction of internal combustion engines and rotary engines as well as rotary machines that various modifications and changes can be made to the described embodiments without departing from the spirit and scope of the present disclosure. Accordingly, all such modifications and changes as follows in the scope of the present disclosure and the accompanying claims are intended to be part of this invention.

We claim:

1. A continuous internal combustion engine comprising:
a combustor operative to produce combustion gases in a combustion chamber and having a fuel and air system for delivering a mixture of fuel and air to said combustion chamber, an ignition device to ignite said mixture of fuel and air, and an extension section which is open at an outer end thereof;
a cylindrical rotor device mounted outside said combustor for rotation about a first axis on a central shaft arrangement and having a cylindrical member with a plurality of axially extending slots formed thereon and distributed about the circumference of said cylindrical member, said cylindrical member having an outer circular cylindrical surface and being mounted to close most of said open outer end of the extension section;
a plurality of vanes extending radially relative to said first axis with each vane mounted in said rotor device for radial movement in a respective one of said slots and with each vane sized to fit in close proximity to adjacent sides of its respective slot, said rotor device having a vane supporting arrangement for supporting the vanes and guiding said vanes during said radial movement;
vane control means for moving each of said vanes between a fully extended position where each vane projects beyond said circular cylindrical surface a maximum distance and a fully retracted position during a revolution of the rotor device; and
a discharge passage for said combustion gases formed between said extension section of said combustor and a circumferentially extending section of said circular cylindrical surface of the cylindrical member, said discharge passage being a gate through which each of said vanes passes in an extended position during operation of said engine, an extended portion of each vane located in the gate projecting radially from said circular cylindrical surface and substantially filling the cross-section of the gate as taken in a radial plane defined by the respective vane,
whereby expanding combustion gases from said combustor pass through said discharge passage and drive each extended vane located in said gate along a circumferential length of said gate in order to rotate said rotor device during operation of said engine.

2. An internal combustion engine according to claim 1 wherein said rotor device has an intermediate cylindrical member and an innermost cylindrical member, both of which are concentric with the first mentioned cylindrical member which forms an outer cylindrical member, all three cylindrical members being connected to two circular end plates located at opposite ends of the cylindrical members, said end plates being rotatably mounted on the central shaft arrangement, and wherein said vane supporting arrangement includes the intermediate and innermost cylindrical members.

3. An internal combustion engine according to claim 2 including a drive coupling member mounted centrally on the exterior of one of said end plates, said coupling member providing means for operatively connecting said rotor device to a transmission.

4. An internal combustion engine according to claim 1 including a valve mounted on a side of said combustor, said valve being adapted to open said combustion chamber to atmosphere when both an acceleration pedal of a vehicle for controlling said engine and a brake pedal of the vehicle are not being pressed by an operator of the vehicle in which the engine is being used.

5. An internal combustion engine according to claim 2 wherein at least one wall forming said combustor is covered by a layer of insulation material in order to reduce heat loss from the combustor.

6. An internal combustion engine according to claim 2 wherein said end plates each have a plurality of air circulating holes formed therein in an annular region between the outer cylindrical member and the intermediate cylindrical member, said holes being provided for cooling purposes, and wherein one of said end plates is provided with fan blades adjacent the holes of said one plate and on an outer surface of said one end plate.

7. An internal combustion engine according to claim 1 wherein said vane control means includes a plurality of rods each pivotally connected at an outer end thereof to a respective one of said vanes and a non-rotating eccentric shaft to which an inner end of each rod is rotatably connected.

8. An internal combustion engine according to claim 7 wherein said plurality of rods include at least two main rods each having a cylindrical sleeve formed on its inner end and extending about said eccentric shaft, and a plurality of auxiliary rods associated with each main rod, each auxiliary rod having an annular inner end section which rides on said sleeve of its respective main rod.

9. An internal combustion engine according to claim 1 wherein said vane control means includes a centrally mounted non-rotating cam shaft with two cam surfaces extending around the cam shaft, two rollers mounted on an inner end of each vane for engagement with said cam surfaces and a spring mounted on each vane so as to bias the vane and its rollers radially inwardly.

10. An internal combustion engine according to claim 1 wherein said vane control means includes electrically operated solenoids with a pair of said solenoids mounted adjacent a respective one of said vanes, two springs mounted on each vane so as to bias its respective vane inwardly from said fully extended position, and connecting rods with a pair of said rods connecting a respective two of said vanes which are arranged diametrically opposite each other in said rotor device.

11. An internal combustion engine according to claim 1 wherein said vane control means includes a plurality of fluid pressure operated pistons mounted in respective cylinders with each piston fixedly connected to a respective vane for movement therewith and connecting rods each of which connects two of said pistons which are arranged on diametrically opposite sides of said first axis.

12. An internal combustion engine according to claim 1 wherein said fuel and air system includes an air pump and a fuel pump both connectible to an output of said rotor device in order to be driven by said rotor device during use of said engine, an air tank for holding pressurized air received from said air pump, an electronically controlled air valve operatively connected to said air tank, a mixing chamber operatively connected to said air valve to receive air under pressure from said air tank when said air valve is open, a fuel accumulator having an inlet connected to said fuel pump, and an electronically controlled fuel injector operatively connected to said fuel accumulator and adapted to inject fuel into said mixing chamber during use of the engine.

13. An internal combustion engine according to claim 1 including an oil lubrication system having an oil reservoir and an oil pump, wherein said rotor device has an oil inlet, an oil outlet, and a centrally mounted, non-rotating eccentric shaft surrounded by a central, oil-containing chamber formed in said rotor device, said oil inlet being operatively connected to said oil pump and opening into said oil containing chamber and said oil outlet being operatively connected to said oil reservoir and to said oil containing chamber.

14. An internal combustion engine according to claim 12 including input sensors for monitoring said combustor and said rotor device and for generating electronic control signals, said input sensors including a first sensor for measuring combustion pressure in said combustion chamber and a second sensor for monitoring the revolutions per minute of said rotor device during use of said engine, and including an electronic controller for controlling engine operation on the basis of said control signals received from said input sensors to which said controller is electrically connected.

15. An internal combustion engine according to claim 1 wherein said fuel and air system includes an air compressor operatively connected to an output device of said rotor device in order to be driven by said rotor device during use of said engine and a heat exchanger adapted for transferring heat from said combustion gases that pass through said discharge passage and said heat exchanger to compressed air pushed through said heat exchanger and into said air tank by said compressor.

16. An internal combustion engine according to claim 1 wherein both said cylindrical member of the rotor device and walls of said combustor including said extension section thereof are each covered by a layer of insulation material in order to reduce heat loss from the combustor.

17. A rotary machine comprising:
a cylindrical rotor device mounted for rotation about a first axis and having a cylindrical member with a plurality of axially extending slots formed therein and distributed about the circumference of said cylindrical member, said cylindrical member having an outer circular cylindrical surface;
a plurality of vanes extending substantially radially, each vane mounted in said rotor device for radial movement in a respective one of said slots, said rotor device having a vane supporting arrangement for supporting the vanes and guiding said vanes during said radial movement;
vane control means for moving each of said vanes between a fully extended position where each vane projects beyond said circular cylindrical surface a maximum distance and a fully retracted position during a revolution of the rotor device;
an air or steam receiving housing adapted for mounting adjacent said rotor device and for receiving air or steam and having an air or steam outlet; and
an air or steam conducting member having an inlet end for air or steam to enter said air conducting member and an outlet end through which air or steam flows into said housing, said conducting member forming a passage extending between said inlet end and said outlet end, said passage being bounded on one side by a circumferentially extending section of said circular cylindrical surface of the cylindrical member which is on one side of the conducting member,
wherein during operation of said rotary machine, an extended portion of each of said vanes passes through and along said passage and projects radially from said circular cylindrical surface while passing through said passage in order to fill substantially the cross-section of the passage as taken in a radial plane defined by the respective vane, whereby each vane in turn either pushes air along said passage and into said housing so that said machine operates as an air pump or is pushed by pressurized air or steam along said passage so that said machine operates as a motor.

18. A rotary machine according to claim 17 wherein said rotor device has an intermediate cylindrical member and an innermost cylindrical member, both of which are concentric with the first mentioned cylindrical member which provides an outer cylindrical member, all three cylindrical members being connected to two circular end plates located at opposite ends of the cylindrical members, said end plates being rotatably mounted on a central shaft arrangement, and wherein said vane supporting arrangement includes the intermediate and innermost cylindrical members.

19. A rotary machine according to claim 17 wherein said vane control means includes a centrally mounted non-rotating cam shaft, a cam roller mounted on an inner end of each vane for engagement with said cam shaft, and a spring mounted on each vane so as to bias the vane and its cam roller radially inwardly, whereby each cam roller engages a cam surface extending around said cam shaft.

20. A rotary machine according to claim 17 wherein said circumferentially extending section of the circular cylindrical surface extends through an arc of less than 90 degrees.

21. A rotary machine according to claim 17 wherein said machine is an air pump, said air receiving housing is adapted for receiving pressurized air, said air outlet of the housing has a one way check valve mounted therein, said check valve permitting airflow from said housing to an air tank, and during operation of said air pump, said rotor device and vanes act to pump external air into said housing via said air conducting member and said rotor device is rotated by a drive device.

22. A rotary machine according to claim 17 wherein said machine is an air or steam motor, said air outlet of the housing is connected so as to exhaust air or steam from the housing, and said inlet end of the conducting member is adapted to receive pressurized air or steam from an air tank or steam source via a second air or steam receiving housing.
